(19) United States
(12) Patent Application Publication
(10) Pub. No.: US 2026/0039676 A1
(43) Pub. Date: Feb. 5, 2026

(54) SYSTEM AND METHOD FOR PROCESSING DATA

(71) Applicant: Arm Limited, Cambridge (GB)

(72) Inventors: Gian Marco Iodice, Cambridge (GB); Ronan Naughton, Ballinasloe (IE); Adnan Hassan A AlSinan, Cambridge (GB); Brendan James Moran, Coton (GB)

(73) Assignee: Arm Limited, Cambridge (GB)

(21) Appl. No.: 19/283,999

(22) Filed: Jul. 29, 2025

(30) Foreign Application Priority Data
Aug. 1, 2024 (GB) 2411358.1

(51) Int. Cl. H04L 9/40; G06F 18/40

(52) U.S. Cl. CPC H04L 63/1425; G06F 18/40

(57) ABSTRACT

According to the present techniques there is disclosed a system comprising a computing resource and a method performed at a computing resource, the method comprising: obtaining, at the computing resource, communication data of a messaging application; executing a ML model to analyze at least one pattern in at least one portion of the communication data; identifying in the pattern, based on the analysis, at least one pair of indicators predictive of undesirable communicative behavior; initiating one or more actions responsive to detecting the indicators of undesirable communicative behavior in the at least one portion of communication data.

The invention relates generally to processing data, and more specifically to processing data using artificial intelligence technology.

Processing data has evolved from simple storing of business transaction records or documents to storing, organizing, and processing more complex content such as photos, videos, and music, such as are captured and shared by the millions every hour by smartphone users.

In addition to processing complex captured information such as video or photos, artificial intelligence systems are increasingly capable of creating written text or artwork that closely mimics content created by people, and can process various inputs to create or modify such works.

One such example area of innovation is the use of artificial intelligence, such as a machine learning (ML) model, to recognize objects or features in data.

There exists the need to improve data processing application on a computing device.

According to a first implementation of the present technology, there is provided a method performed at a computing resource comprising: obtaining, at the computing resource, communication data of a messaging application; executing a ML model to analyze at least one pattern in at least one portion of the communication data; identifying in the pattern, based on the analysis, at least one pair of indicators predictive of undesirable communicative behavior; initiating one or more actions responsive to detecting the indicators of undesirable communicative behavior in the at least one portion of communication data.

According to a further implementation of the present technology, there is provided a computing resource comprising: a processor; communication circuitry to receive communication data from another resource; storage to store communication data of one or more messaging applications and one or more ML models; where the processor is operable to: access, in the storage at the device, the communication data; execute an ML model to analyze at least one pattern in at least one portion of the communication data; identify in the pattern, based on the analysis, at least one pair of indicators predictive of undesirable communicative behavior; and initiate one or more actions responsive to detecting the indicators of undesirable communicative behavior in the at least one portion of communication data.

In a further implementation, there may be provided a computer program comprising computer program code to, when loaded into a processor and executed thereon, cause the processor to perform the method according to an implementation of the present technology.

The claims provided in this application are not limited by the examples provided in the specification or drawings, but their organization and/or method of operation, together with features, and/or advantages may be best understood by reference to the examples provided in the following detailed description and in the drawings, in which:

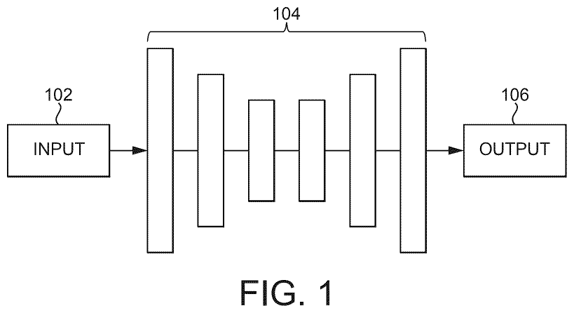

FIG. 1 shows an example analysis architecture in accordance with the present techniques;

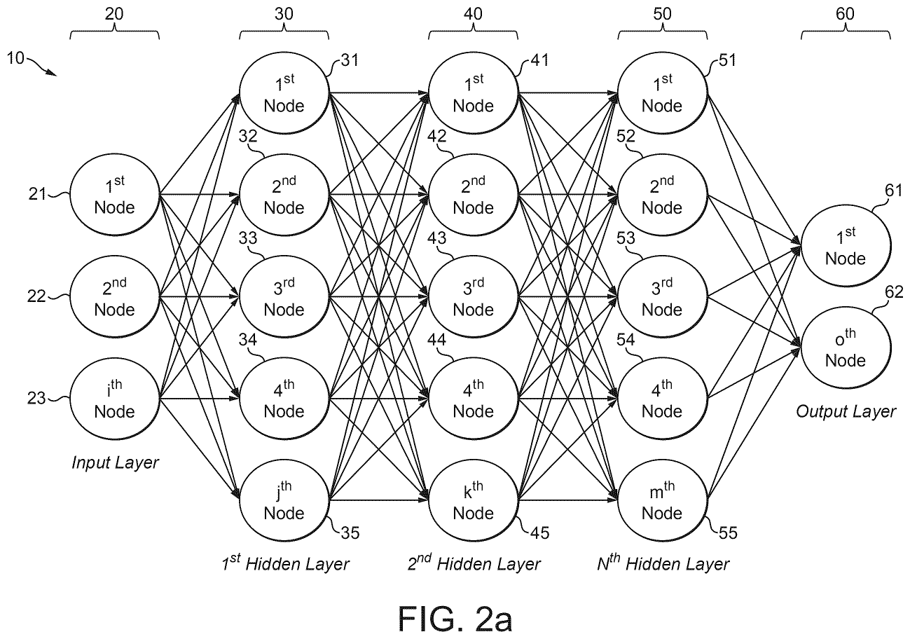

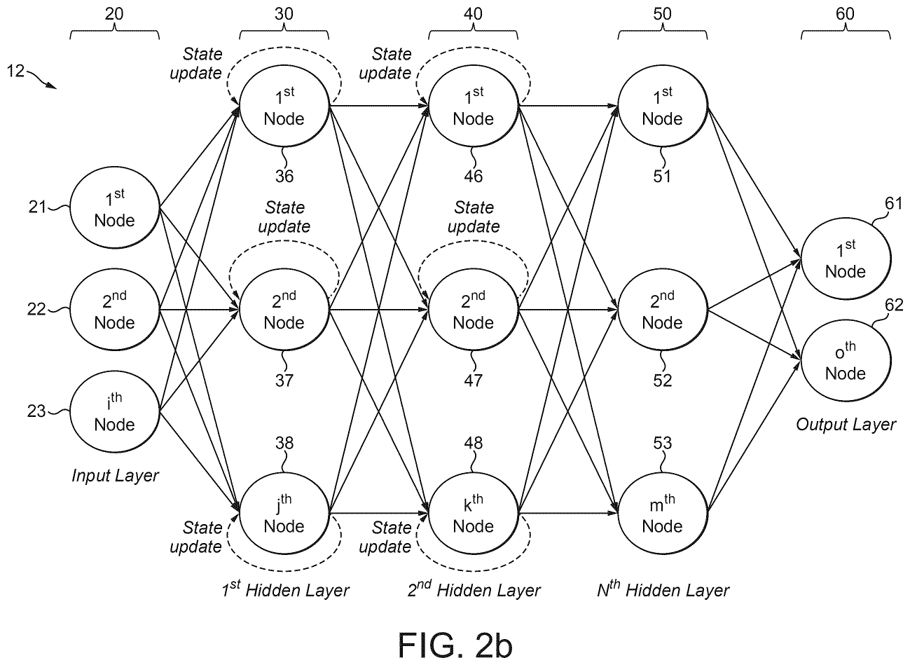

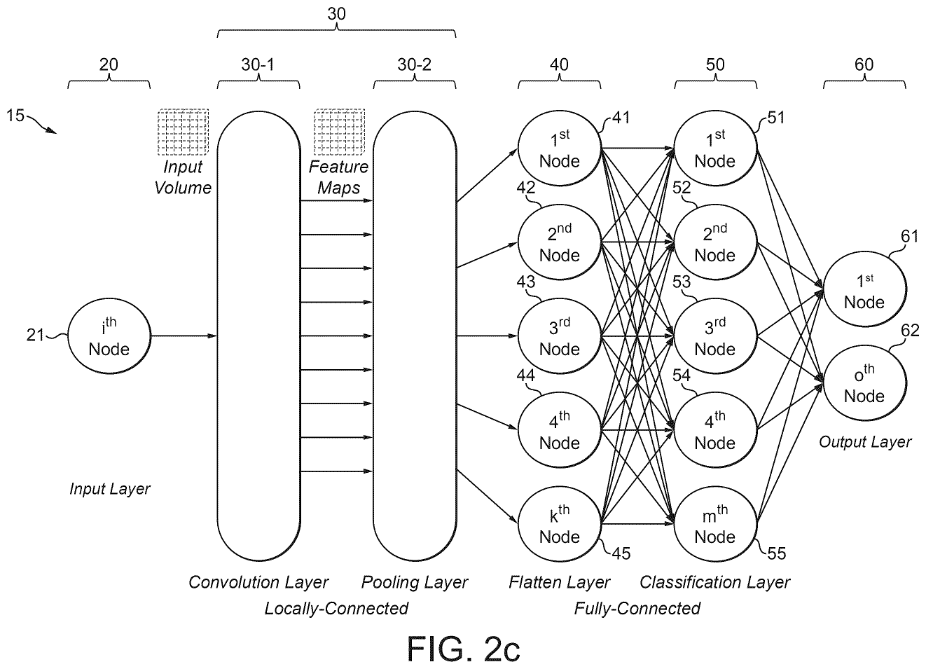

FIGS. 2a to 2c show more detailed examples of analysis architecture in accordance with the present techniques;

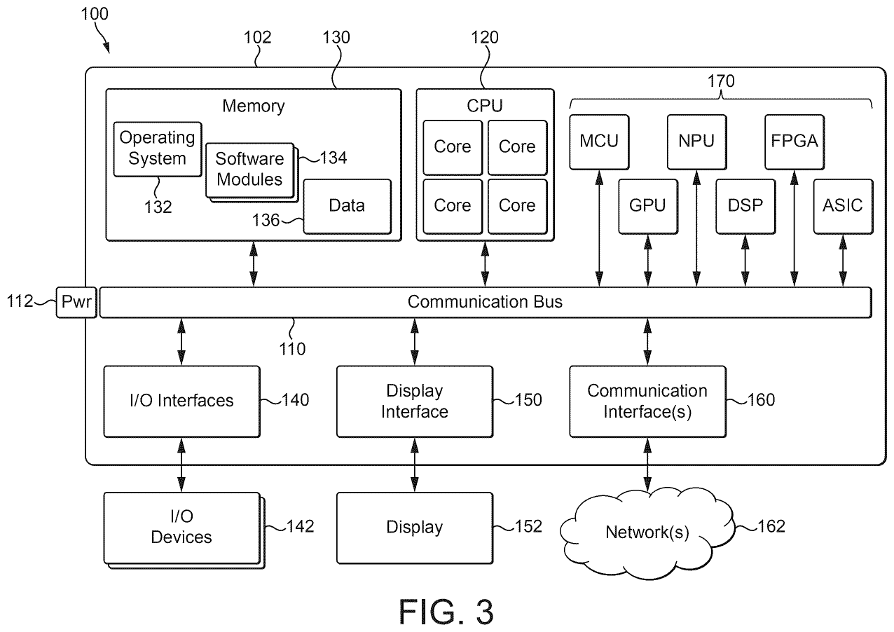

FIG. 3 shows a block diagram of an example computing system which may utilize the analysis architecture of FIG. 1 in accordance the present techniques;

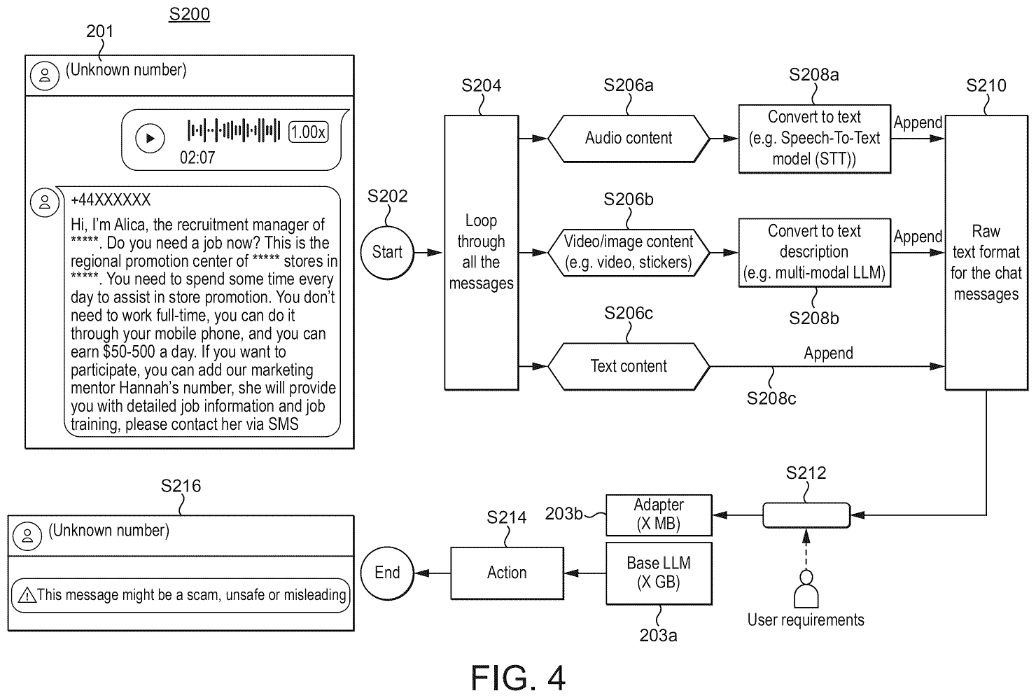

FIG. 4 is a flow diagram in accordance with the present techniques; and

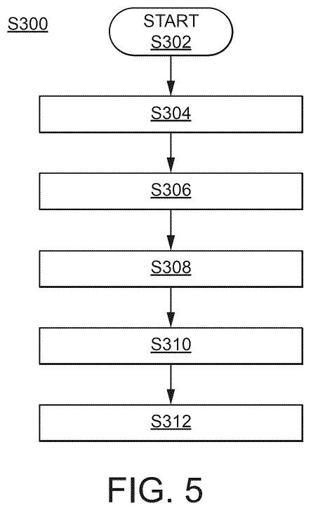

FIG. 5 is a flow diagram of a method of processing data in accordance with the present techniques.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Other embodiments may be utilized, and structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Artificial intelligence techniques such as ML models are often used to process complex information such as text and images in training and inferencing operations.

Embodiments described herein are directed to providing analysis of data on a user device utilizing generative artificial intelligence (GAI), such as by using analysis architecture comprising a ML model.

In particular implementations, ML models may enable improved results in a wide range of tasks, including text, image, video and speech processing, just to provide a couple of example applications. To enable performing such tasks, features of a ML model may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, the ML model may comprise one or more neural networks (e.g., nodes, edges, weights, layers of nodes and edges), where intelligent computing devices to perform functions supported by neural networks may comprise a wide variety of stationary and/or mobile devices, such as, for example, smart mobile phones, wearable devices, Internet of things (IoT) devices, personal digital assistants (PDAs), virtual assistants, laptop computers, personal entertainment systems, tablet personal computers (PCs), PCs, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to text, image and/or video recognition, recommender systems, image classification, image segmentation, medical image analysis, natural language processing, brain-computer interfaces, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., storage (memory)) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

A neural network (NN) (e.g., CNN, RNN etc.) may have multiple hidden layers in order to model complex, nonlinear relationships between input data and output data, where such neural networks are referred to as deep neural networks (DNN).

A large language model (LLM) which includes a transformer neural network architecture (e.g., decoder-only transformer-based architecture) may be built on one or more DNNs. Such an LLM generates context-aware content in response to user interactions.

FIG. 1 shows an example analysis architecture 1 in accordance with the present techniques. Here, an input signal 2 is fed into processing stages 4. The input in various examples comprises data having various values, parameters and/or states encoded therein, such as text or an image having definable objects, edges, colors, and other characteristics, or other values, parameters, states, etc.

Processing stages 4 in this example has six layers. In one embodiment, one or more such layers may comprise a group of nodes connected to nodes in previous and subsequent layers. In some examples, nodes in a layer may be “fully connected,” or connected to every node in a preceding and subsequent layer, while other processing architectures may have more complex connection structures linking layers and nodes. A node in a particular layer of processing stages may implement an activation function, which may be determined, at least in part, by learning processes such as backpropagation of errors in output detected using ground truth observations. A fully trained network may comprise static coefficients (or tensors) associated with nodes and/or layers, which along with an activation function define how an output value(s) of each node is derived from input value(s). Activation functions in various examples may be linear, such as multiplying an input by a static coefficient, or nonlinear, such as using logarithmic or exponential functions of the node's inputs along with node coefficients or tensors to derive the output. More detailed examples of ML models which may be used as analysis architectures in accordance with the present techniques are described in FIGS. 2a-2c.

FIG. 2a depicts an ANN 10, which may be used as an analysis architecture in accordance with an embodiment of the present disclosure.

ANN 10 includes input layer 20, one or more hidden layers 30, 40, 50, etc., and output layer 60. Input layer 20 includes one or more input nodes 21, 22, 23, etc. Hidden layer 30 includes one or more hidden nodes 31, 32, 33, 34, 35, etc. Hidden layer 40 includes one or more hidden nodes 41, 42, 43, 44, 45, etc. Hidden layer 50 includes one or more hidden nodes 51, 52, 53, 54, 55, etc. Output layer 60 includes one or more output nodes 61, 62, etc. Generally, ANN 10 includes N hidden layers, input layer 20 includes “i” nodes, hidden layer 30 includes “j” nodes, hidden layer 40 includes “k” nodes, hidden layer 50 includes “m” nodes, and output layer 60 includes “o” nodes.

In one embodiment, N equals 3, i equals 3, j, k and m equal 5 and o equals 2 (depicted in FIG. 1). Input node 21 is coupled to hidden nodes 31 to 35, input node 22 is coupled to hidden nodes 31 to 35, and input node 23 is coupled to hidden nodes 31 to 35. Hidden node 31 is coupled to hidden nodes 41 to 45, hidden node 32 is coupled to hidden nodes 41 to 45, hidden node 33 is coupled to hidden nodes 41 to 45, hidden node 34 is coupled to hidden nodes 41 to 45, and hidden node 35 is coupled to hidden nodes 41 to 45. Hidden node 41 is coupled to hidden nodes 51 to 55, hidden node 42 is coupled to hidden nodes 51 to 55, hidden node 43 is coupled to hidden nodes 51 to 55, hidden node 44 is coupled to hidden nodes 51 to 55, and hidden node 45 is coupled to hidden nodes 51 to 55. Hidden node 51 is coupled to output nodes 61 and 62, hidden node 52 is coupled to output nodes 61 and 62, hidden node 53 is coupled to output nodes 61 and 62, hidden node 54 is coupled to output nodes 61 and 62, and hidden node 55 is coupled to output nodes 61 and 62.

Many other variations of input, hidden and output layers are clearly possible, including hidden layers that are locally-connected, rather than fully-connected, to one another.

Training an ANN includes optimizing parameters, such as the connection weights between nodes by minimizing the prediction error of the output data until the ANN achieves a particular level of accuracy. One method is backpropagation, or backward propagation of errors, which iteratively and recursively determines a gradient descent with respect to the connection weights, and then adjusts the connection weights to improve the performance of the network.

A multi-layer perceptron (MLP) is a fully-connected ANN that has an input layer, an output layer and one or more hidden layers. MLPs may be used for natural language processing applications, such as machine translation, speech recognition, etc. Other ANNs include recurrent neural networks (RNNs), sequence-to-sequence models that include an encoder RNN and a decoder RNN, long short-term memories (LSTMs), gated recurrent units (GRUs), memory-augmented neural networks (MANNs), transformer neural networks, shallow neural networks, etc.

FIG. 2b depicts an RNN, in accordance with an embodiment of the present disclosure. Generally, RNNs process input sequence data and generate output sequence data, and may be used for many different applications, such as, for example, natural language processing applications (e.g., sentiment analysis, speech recognition, reading comprehension, summarization and translation, etc.), image processing (e.g., image captioning, video classification, etc.), etc. RNNs may be programmed to process many different types of input and output data, such as, for example, fixed input data and fixed output data for image classification, etc., fixed input data and sequential output data for image captioning, etc., sequential input data and fixed output data for sentence “sentiment” classification, etc., sequential input data and sequential output data for machine translation, etc., synced sequential input data and sequential output data for video classification, etc.

RNN 12 includes input layer 20, one or more hidden layers, such as recurrent layer 30, one or more additional recurrent layers 40, hidden layer 50, etc., and output layer 60. Many other variations of input, hidden and output layers are contemplated.

Input layer 20 includes one or more input nodes 21, 22, 23, etc., that presents the input data, such as sequences of letters, words, sentences, etc., images, audio data, etc. to hidden layer 30.

Hidden layer 30 is a fully connected, recurrent layer that includes one or more recurrent nodes 36, 37, 38, etc. Each hidden (recurrent) node 36, 37, 38, etc. maintains a state or hidden vector, which is updated at each time step (t) of RNN 12. Generally, each recurrent node updates its state or hidden vector (ht) by applying a function to the sum of the previous hidden vector (ht-1) multiplied by a weight vector (Wstate) and the current input data (xt) multiplied by another weight vector (Winput). The function may be a non-linear activation function, such as, for example, ReLu, tanh () etc., applied element-by-element. The output of each recurrent node (yt) is the product of the hidden vector multiplied by another weight vector (Woutput). One or more additional, fully-connected, hidden (recurrent) layers 40 may follow hidden (recurrent) layer 30, and may include one or more hidden (recurrent) nodes 46, 47, 48, etc. Hidden layer 50 is a fully-connected layer that includes one or more hidden nodes 51, 52, 53, etc. In certain embodiments, hidden layer 50 may be a classification layer.

Output layer 60 is a fully-connected layer that includes one or more output nodes 61, 62, etc. In certain embodiments, fully-connected output layer 60 may receive the classification results output by hidden layer 50, and each output node provides an output, such as a predicted class score, probability of a word, sentence, etc. A normalization function, such as a Softmax function, may be applied to the output by output layer 60, or, alternatively, by an additional layer interposed between hidden layer 50 and output layer 60.

Similar to ANNs, training an RNN includes optimizing parameters such as the connection weights between nodes by minimizing the prediction error of the output data until the RNN achieves a particular level of accuracy. As noted above, backpropagation through time may be used to iteratively and recursively determines a gradient descent with respect to the weights, and then adjusts the weights to improve the performance of the RNN.

A CNN is a variation of an MLP that may be used for classification or recognition applications, such as image recognition, speech recognition, etc. A CNN has an input layer, an output layer and multiple hidden layers including convolutional layers, pooling layers, normalization layers, fully-connected layers, etc. Each convolutional layer applies a sliding dot product or cross-correlation to an input volume, applies an activation function to the results, and then provides the activation or output volume to the next layer. Convolutional layers typically use the ReLu function as the activation function. In certain embodiments, the activation function is provided in a separate activation layer, such as, for example, a ReLu layer. A pooling layer reduces the dimensions of the output volume received from the preceding convolutional layer, and may calculate an average or a maximum over small clusters of data, such as, for example, 2×2 matrices. In certain embodiments, a convolutional layer and a pooling layer may form a single layer of a CNN. The fully-connected layers follow the convolutional and pooling layers, and include a flatten layer and a classification layer, followed by a normalization layer that includes a normalization function, such as the SoftMax function. The output layer follows the last fully-connected layer; in certain embodiments, the output layer may include the normalization function.

FIG. 2c depicts a CNN, in accordance with an embodiment of the present disclosure. CNN 15 includes input layer 20, one or more hidden layers, such as convolutional layer 30-1, pooling layer 30-2, hidden (flatten) layer 40, hidden (classification) layer 50, etc., and output layer 60. Many other variations of input, hidden and output layers are contemplated.

Input layer 20 includes one or more input nodes 21, etc., that present the input data, such as a color image, as an input volume to the first convolutional layer, e.g., convolutional layer 30-1. The input volume is a three-dimensional matrix that has a width, a height and a depth. For example, input data that represent a color image are presented as an input volume that is 512 pixels×512 pixels×3 channels (red, green, blue); other input volume dimensions may also be used, such as 32×32×3, 64×64×3, 128×128×3, etc., 32×32×1, 64×64×1, 128×128×1, 512×512×1, etc.

Convolutional layer 30-1 is locally-connected to input layer 20, and includes a plurality of nodes that are connected to local regions in the input volume (not depicted for clarity). For a CNN that uses a standard convolution, each node computes a dot product between the node's weights and the respective local region of the input volume. An activation function is then applied to the results of each convolution calculation to produce an output volume that is provided as an input volume to the subsequent layer. The activation function may be applied by each convolutional layer node or by the nodes of a subsequent locally-connected ReLu layer.

Pooling layer 30-2 is locally-connected to convolutional layer 30-1, and includes a plurality of nodes that are connected to local regions in the input volume (not depicted for clarity). Pooling layer 30-2 also produces an output volume that is provided as the input volume to the subsequent layer, such as, for example, another convolutional layer 30-1, a flatten layer 40, etc. In certain embodiments, convolutional layer 30-1 and pooling layer 30-2 form a single hidden layer 30. Similarly, in certain embodiments, convolutional layer 30-1, a ReLu layer and pooling layer 30-2 form a single hidden layer 30. Generally, the output volumes of the convolutional and pooling layers may be described as feature maps, and one or more single hidden layers 30 form a feature learning portion of CNN 15.

Hidden layer 40 is a “flatten” layer that is locally-connected to pooling layer 30-2, and includes one or more hidden (flatten) nodes 41, 42, 43, 44, 45, etc. Hidden (flatten) layer 40 “flattens” the output volume produced by the preceding pooling layer 30-2 into a column vector, which is provided to the subsequent, fully-connected hidden layer 50.

Hidden layer 50 is a classification layer that is fully-connected to hidden (flatten) layer 40, and includes one or more hidden (classification) nodes 51, 52, 53, 54, 55, etc.

Output layer 60 includes one or more output nodes 61, 62, etc., and is fully-connected to hidden (classification) layer 50. Fully-connected output layer 60 receives the classification results output by hidden (classification) layer 50, and each node outputs a predicted class score. A normalization function, such as a Softmax function, may be applied to the predicted class scores by output layer 60, or, alternatively, by an additional layer interposed between hidden (classification) layer 50 and output layer 60.

Similar to ANNs, training a CNN includes optimizing parameters such as the connection weights between nodes by minimizing the prediction error of the output data until the CNN achieves a particular level of accuracy. As noted above, backpropagation may be used to iteratively and recursively determines a gradient descent with respect to the connection weights, and then adjusts the connection weights to improve the performance of the network. Matrix multiplication operations, and, more particularly, multiply-and-accumulate (MAC) operations, are used extensively by ANNs, CNNs, etc.

As above, a transformer neural network architecture may be built on one or more DNNs to provide a LLM to generate context-aware content in response to user interactions.

One or more of the analysis architectures described above may be utilized by a computing device such as a personal user device (e.g., a smartphone), although the claims are not limited in this respect.

In an illustrative example, the computing device may include an application that utilizes analysis architecture for processing data (e.g., text data, image data, speech data) generated or received at the computing device. Furthermore, the computing device may utilize plural analysis architectures for analysing two or more different types of data (i.e., multimodal data analysis).

The one or more analysis architecture(s) may, in some examples, be implemented in software, where various nodes, tensors, activation functions, and other elements of processing stages of a NN may be stored in data structures in storage.

In other examples, the analysis architecture may be implemented in hardware, such as a convolutional neural network structure that is embodied within the transistors, resistors, and other elements of an integrated circuit. In an alternate example, the analysis architecture may be implemented in a combination of hardware and software, such as a neural processing unit (NPU) having software-configurable weights, network size and/or structure, and other such configuration parameters.

The analysis architecture as described herein in particular examples, may be formed in whole or in part by and/or expressed in transistors and/or lower metal interconnects (not shown) in processes (e.g., front end-of-line and/or back-end-of-line processes) such as processes to form complementary metal oxide semiconductor (CMOS) circuitry. The various blocks, neural networks, and other elements disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

FIG. 3 shows a block diagram of an example computing system 100 which may utilize the analysis architecture in accordance the present techniques.

In the present illustrative example the computing system 100 comprises a user computing device (e.g., smartphone).

System 100 includes communication bus 110 coupled to one or more processors 120, storage 130, I/O interfaces 140, display interface 150, one or more communication interfaces 160. In the illustrative example the system is depicted as having one or more hardware accelerator (HA) 170 although the claims are not limited in this respect.

Processor 120 includes one or more general-purpose or application-specific microprocessors that executes instructions to perform control, computation, input/output, etc. functions for system 100. Processor 120 may include a single integrated circuit, such as a micro-processing device, or multiple integrated circuit devices and/or circuit boards working in cooperation to accomplish the functions of processor 120. Additionally, processor 120 may include multiple processing cores, as depicted in FIG. 3. Generally, system 100 may include one or more processors 120, each containing one or more processing cores.

For example, system 100 may include 2 processors 120, each containing multiple processing cores.

In an embodiment, processor 120 may be configured to provide the analysis architecture by executing one or more ML models, such as, for example, ANNs, CNNs, RNNs, DNNs and LLM In these embodiments, processor 120 may provide the same functionality as a hardware accelerator, such as HA 170.

Generally, storage (or memory) 130 stores instructions for execution by processor 120 and data. Storage 130 may include a variety of non-transitory computer-readable medium that may be accessed by processor 120. In various embodiments, storage 130 may include volatile and non-volatile medium, non-removable medium and/or removable medium. For example, storage 130 may include any combination of random access memory (RAM), dynamic RAM (DRAM), static RAM (SRAM), read only memory (ROM), flash memory, cache memory, and/or any other type of non-transitory computer-readable medium.

Storage 130 may comprise various components for retrieving, presenting, modifying, and storing data. For example, storage 130 may store software modules that provide functionality when executed by processor 120. The software modules include operating system 132 that provides operating system functionality for system 100. Software modules 134 provide various functionality, such as the analysis functionality using NN(s). Data 136 may include data associated with operating system 132, software modules 134, etc.

I/O interfaces 140 are configured to transmit and/or receive data from I/O devices 142. I/O interfaces 140 enable connectivity between processor 120 and I/O devices 142 by encoding data to be sent from processor 120 to I/O devices 142, and decoding data received from I/O devices 142 for processor 120. Generally, data may be sent over wired and/or wireless connections. For example, I/O interfaces 140 may include one or more wired communications interfaces, such as USB, Ethernet, etc., and/or one or more wireless communications interfaces, coupled to one or more antennas, such as WiFi, Bluetooth, cellular, etc.

Generally, I/O interfaces 140 are coupled to I/O devices 142 using a wired or wireless connection, display interface 150 is coupled to display 152, and communication interface 160 is connected to network 162 using a wired or wireless connection. In many embodiments, certain components of system 100 are implemented as a system-on-chip (SoC) 102; in other embodiments, system 100 may be hosted on a traditional printed circuit board, motherboard, etc.

Communication bus 110 is a communication system that transfers data between processor 120, storage 130, I/O interfaces 140, display interface 150, communication interface 160, HAs 170, as well as other components not depicted in FIG. 4. Power connector 112 is coupled to communication bus 110 and a power supply (not shown). In certain embodiments, communication bus 110 is a network-on-chip (NoC).

Generally, I/O devices 142 provide input to system 100 and/or output from system 100. As discussed above, I/O devices 142 are operably connected to system 100 using a wired and/or wireless connection. I/O devices 142 may include a local processor coupled to a communication interface that is configured to communicate with system 100 using the wired and/or wireless connection. For example, I/O devices 142 may include a keyboard, mouse, touch pad, joystick, etc.

Display interface 150 is configured to transmit image data from system 100 to monitor or display 152.

Communication interface 160 is configured to transmit data to and from network 162 using one or more wired and/or wireless connections. Network 162 may include one or more local area networks, wide area networks, the Internet, etc., which may execute various network protocols, such as, for example, wired and/or wireless Ethernet, Bluetooth, etc. Network 162 may also include various combinations of wired and/or wireless physical layers, such as, for example, copper wire or coaxial cable networks, fiber optic networks, Bluetooth wireless networks, WiFi wireless networks, CDMA, FDMA and TDMA cellular wireless networks, etc.

As above, the system 100 is depicted as comprising HAs 170. Such HAs 170 may be configured to execute one or more ML model(s) (such as, for example, ANNs, CNNs, RNNs, DNNs, LLMs etc.) to provide the analysis functionality for various applications embodied by software modules 134. Generally, HA 170 includes one or more processors, coprocessors, processing engines (PEs), compute engines (CEs), etc., such as, for example, CPUs, MCUs, GPUs, NPUs, such as, for example, the ARM Machine Learning (ML) Processor, DSPs, field programmable gate arrays (FPGAs), application specific integrated circuits (ASICs), controllers, microcontrollers, matrix multiplier circuits, MAC arrays, etc. HAs 170 also include a communications bus interface as well as non-volatile and/or volatile memories, such as, for example, ROM, flash memory, SRAM, DRAM, etc.

In certain embodiments, the ML model(s) and parameters (e.g. weights) may be stored in non-volatile storage 130 and accessed by software (e.g. applications) executed by the CPU 120 (or one or more HAs 170) via communication bus 160 (e.g. using direct memory access (DMA)) In other embodiments, the ML model(s) and parameters may be provided from storage 130 over communication bus 110 for storage in local volatile memory (e.g., local SRAM). In certain embodiments, the ML architecture may be directly implemented in hardware using PEs, CEs, matrix multiplier units, MAC arrays, etc. Generally, HAs 170 receive input data from storage 130 over communication bus 110, and transmit output data to storage 130 over communication bus 110.

The ML model may be executed in a trusted or protected execution environment (hereafter “trusted execution environment”), where the ML model and associated parameters (e.g., the inputs (e.g., communication data), weights, activation functions, and the outputs) are accessible only to an authorized application or process running on the user device. Such protection may be provided by use of hardware and/or software.

As an illustrative example of a trusted execution environment, communication data may be encrypted, such that only an authorized application or process may decrypt the communication data. As a further example, application data generated by one or more applications running on the system may be stored in storage 130 in a secure manner. For example, such data may be encrypted prior to being stored.

Additionally, or alternatively, in a further illustrative example of a trusted execution environment the computing system 100 may operate with different privilege modes, where each privilege mode can give different rights of access to data. A privilege mode with a higher level of privilege will typically have access to more system resources, where a system resource may be a storage region, peripheral device, more function, data etc.) than are available in a lower privilege mode. Hypervisor code may be provided with a highest privilege mode of operation so as to control access to system resources that are provided to other processes, such as application code, executing on the system, thereby preventing access to system resources (e.g., data) by unauthorized code.

In a further illustrative example of a trusted execution environment, storage access circuitry may be provided to control access to a number of storage regions (e.g., of a memory address space in storage) based on ownership information which defines, for a given storage region, an owner realm specified from among a plurality of realms. Each realm may correspond to at least a portion of at least one software process. The owner realm for a given storage region has the right to exclude other realms from accessing data (e.g., ML models, weights, application data, communication data etc.) stored within the given storage region. Hence, in contrast to a privilege-based model where access permissions may define which processes are allowed to access (read or write) a given storage (memory) region, with the realm-based approach, the owner realm has the ability to control which other realms access its owned storage regions such that different parts of the address space can be allocated different realm owners who have control over access to that part of the address space. Thus, a given realm owner can protect its data from access by other processes including processes operating at the same privilege level or at higher privilege levels.

In some examples, this realm-based approach may be applied in parallel with privilege-based protection model, so that there are multiple overlapping sets of access rights for a given storage region: the privilege-based permissions set by a higher-privilege process, and the access permissions set by the owner realm of the corresponding storage region, where access to data in a particular storage location may be allowed if it satisfies both sets of permissions.

A realm management unit (not shown) may be provided to control operation of a given realm based on security configuration parameters associated with the given realm. For example the security configuration parameters could define information such as a realm type (which may govern what properties the realm has or what operations the realm is able to carry out), a protected address range associated with the given realm (which may mark the bounds of the storage regions which can securely be accessed by the given realm), and other information about whether operation such as debugging or export of data from a storage protector using the storage access circuitry to an external storage outside the bounds of protection by the storage access circuitry would be permitted.

In an implementation of the present technology, a confidential realm may be established such that it can attest to the user or client that the realm environment is secured as expected—that is, that all elements of the realm, such as the bootloader, operating system, and all the processing and data storage resources required are guaranteed to be as claimed and to meet security and integrity requirements. Such a realm is then suitable to be provisioned with the communication data and the model, and the security and integrity of the whole are provided under public key protection via a single secure and attested communications connection.

After the execution of the present technology in a realm as described, any new learning applied to the model may be preserved only by transmitting it to the requesting entity (such as a client or user device) for secure storage at the requesting entity. Any communication and model data, which may potentially expose confidential information, is securely and with a guarantee destroyed either during realm teardown or by any of the known secure explicit deletion mechanisms.

In an illustrative example, the present technology may exploit a trusted execution environment in the form of a private cloud environment, wherein the ML model is operated on a dedicated, isolated processor that is trusted and attested having a single trusted and attested communication channel for communication with the user device.

The computing system can run various communications applications.

Such communication applications may relate to communications between a user using the computing system (e.g., a mobile phone as per the present illustrative example) and another computing resource (e.g., a mobile phone, PC or laptop), where the user may receive communication data from another user using that other remote resource.

Such communication data may comprise voice communication data (e.g., cellular calls, voice over IP calls; voicemails etc.); media communication data (e.g., video chats; video messages; images); text communication data (e.g., SMS messages; instant messaging (IM); direct messaging via social media platforms; emails etc.). Within the communication data there may also be additional data that is used to communicate or indicate reactions, ideas, intentions or emotions (hereafter “reaction data”) of another user. Such reaction data may comprise graphics interchange format (GIF) data, emojis and stickers, although the claims are not limited to just these three types of reaction data.

In some cases, a rogue 3^{rd} party may attempt to communicate with a user over one or more communications to extract information (e.g., passwords, bank details etc.) from an unwitting user. Additionally, or alternatively, a rogue 3^{rd} party may attempt to communicate with a user over one or more communications to manipulate, exploit or coerce a user (e.g., a minor or vulnerable person) into doing something inappropriate (e.g., send inappropriate videos or images) or to meet the rogue 3^{rd} party. Additionally, or alternatively, a rogue 3^{rd} party may attempt to communicate with a user via one or more communications to send the user inappropriate images, videos or text, or to bully that user.

Such malicious or rogue behavior over a pattern of communications is hereafter referred to as “undesirable communicative behavior.”

The present techniques provide for analyzing, using one or more ML models, at least a portion of communication data received by a user to identify such undesirable communicative behavior and, when identified, to initiate an appropriate action(s) or response(s).

In an illustrative example, the analysis may be performed at a computing resource, and may be initiated responsive to a stimulus such as the user receiving communication data (e.g., an instant message (IM), DM, SMS, email image, video etc.) from one or more remote resources (e.g., one or more computing systems).

The action or response may be an alert provided to the user (e.g. using text or images via a display; or a sound via a speaker) or the user device may inform, e.g. via email, SMS or otherwise, a trusted person associated with the user (e.g. a parent, guardian etc.), or other authorities (e.g. social care or police) that undesirable communicative behavior was detected on the user's device.

An example implementation of the analysis functionality on a computing resource is depicted in the process flow diagram 200 of FIG. 4. In the example depicted in FIG. 4 the computing resource is a user device (e.g., a mobile phone). In a further illustrative example, the computing resource may be a server or cloud service to perform the analysis on communication data received from a user device.

At S202, the process starts, where, responsive to a stimulus (e.g., new communication data received at the user device), an analyser at the user device initiates an analysis of at least a portion of the communication data 201 on the user device.

In the present illustrative example, the communication data comprises a plurality of different types of communication data such as audio, text, images, video, reaction data etc. received from one or more other users via one or more different platforms (e.g., WhatsApp; TikTok, Facebook, Instagram; Gmail etc.).

As described above, the communication data, when received, may be stored in storage (e.g., volatile or non-volatile storage) such that it is only accessible by an authorized process or application running on the user device.

At S204, the analyser may access the received communication data and at S206 identify different modes or types of data e.g., voice memos or notes; images, videos, reaction data, text, and metadata, such as time, date, geolocation and the like. (depicted as S206a-c)

At S208a-c, the analyser uses suitable applications or models (e.g., ML models(s)) to convert the different modes or types of communication data to a format (e.g. raw text format) for input into a further ML model 203 (e.g., LLM). For example, at S208a, a voice to text (STT) model may be used to convert voice memos/voicemails or audio in a video to text. Further, at S208b a multi-modal LLM may be used to convert reaction data to raw text format. In an illustrative example an automated description of visual objects may be used (e.g., a thumbs up or smiley face emoji may be converted to a “yes;” whereas a thumbs down or sad face etc. may be converted to be a “no”). As a further example, at S208c software (e.g., a NN) may convert text message data in the communication data to the raw text format for the further ML model.

In further implementations, the different modes or types of communication data, including multimedia data, may be processed using non-language-based modelling and inferencing systems.

At S210 the formatted data derived from the communication data may be securely stored in storage (e.g., volatile or non-volatile storage) such that it is inaccessible by untrusted processes or applications.

At S212 the analyser, dependent on, for example, the requirements of the user (e.g., responsive to the user command or query), passes the first communication data to an ML model 203 for analysis. In the present embodiments the ML model 203 is adapted to identify “undesirable communicative behavior.”

In embodiments the ML model may be trained to detect communication data indicative of undesirable communicative behavior. In an illustrative example, the ML model 203 may detect hyperlinks in SMS or IM messages that lead to fraudulent websites. In a further illustrative example the ML model S203 may detect when the user received articles comprising misinformation or “fake news” or based on metadata in the communication data, determine that communication data originated in an area of the world known for undesirable communications.

In a further illustrative example, the ML model may detect images or videos in communication data that are inappropriate for a particular user (e.g., nude or pornographic images or videos when the user is a minor or vulnerable person).

In a further illustrative example, the ML model may detect patterns of undesirable communicative behavior in communication data over time (e.g. hours, days, weeks etc.), where the initial messages from one or more 3^{rd} parties may be appropriate (e.g. to gain the trust of the user), but where subsequent messages in the exchange may be indicative of undesirable communicative behavior (e.g. coercive behaviour; bullying; exploitation etc.). Thus, the ML model is trained to understand the context of message exchange to determine whether or not there is undesirable communicative behavior in exchanges between a user and one or more entities.

In an illustrative example, the ML model 203 may comprise a NN or LLM, where the parameters (e.g., weights, activation functions) of the NN or LLM are tuned for identifying undesirable communicative behavior. In a further illustrative example, and as depicted in FIG. 4, the ML model may comprise one or more adapters 203ₘ (where ‘m’ is an integer) applied on top of a base ML model, where the parameters of each adapter may be configured to identify undesirable communicative behavior.

FIG. 4 depicts ML model 203, which comprises a base LLM 203a, and where the ML model further comprises an undesirable communicative behavior adapter 203b. The parameters of the communicative behavior adapter 203b may be tuned to provide the required functionality. The ML model 203a and the adapters 203b and the respective parameters may be stored in secure storage and access may only be provided to a trusted processes/application(s).

The ML model 203a and adapters 203b may be trained using any of the known supervised learning techniques applied to corpora of message data, (e.g. collections of message logs, police files, bank fraud detection databases, and the like), to provide outputs with above-threshold probability of accurately representing predictive patterns indicating early signs that undesirable communicative behaviour is developing in the communications.

In embodiments the ML model 203a and adapter 203b may be trained at a remote resource (e.g., a cloud service) and provisioned on the user device for inference operations.

The ML model 203a and adapter 203b may be trained using communication data from previous victims of undesirable communicative behaviour (e.g., chat logs from scam victims or grooming victims; DMs and/or IMs from bullying victims etc.). Further the ML model 203 can be trained on sequence of messages building up to a scam or leading to other undesirable communicative behavior (e.g., exploitation etc.).

It will also be appreciated that the ML model 203 may have different threshold levels for what is considered undesirable communicative behaviour e.g., to distinguish between actual malicious communicative behavior and lowbrow communications between the user and another user or users. For example, an adult user may be in a group with other adult users that exchange sarcastic messages or adult images that would be inappropriate for minors. Thus, the ML model 203 may take account of a user profile or user settings when determining when communication data is undesirable communication data. In a further example, a user may add other users to a whitelist of users, where communication data from those users is not analysed for certain types of undesirable communicative behaviour (e.g. images, videos, coercive behaviour, bullying etc.), but where the ML model 203 may still check for fraud (e.g. through hyperlinks) in the event of a computing resource of a whitelisted user being hacked by a rogue 3^{rd} party.

At S214, when undesirable communicative behavior is identified in communication data then an action may be initiated. The action that is initiated may be dependent on, for example, the user (e.g. where the action may be different if the user is a minor (e.g. <18 years old); or if the user is a vulnerable person) or the type of undesirable communicative behavior detected (e.g. where the police may be informed if exploitation of a minor is detected; or where a parent may be alerted when bullying is detected; or where the user of the device is alerted to a potential scam). An alert 216 may be provided to a user (or parent, guardian etc.), e.g., as text via a display, and the length/format of the summary may be defined (e.g., via settings on the user device). In a further example, an alert may be provided as an audio alert via a speaker. Further examples of types actions are described below.

The results from the ML model 203 may be stored securely so as to be accessible only by an authorized application.

At the end of each operation, in an embodiment, no training is performed in respect of the ML model and the parameters (e.g., weights) are not updated. The same ML model 203 may be used for each subsequent analysis operation. Such functionality preserves privacy of the ML model and communication data and mitigates the risk of a 3^{rd} party altering the ML model to avoid a particular undesirable communicative behavior being detected. However, such functionality, where the ML model is not updated means that the ML model may not detect undesirable communicative behavior that evolves to avoid detection by that particular ML model.

Thus, in further embodiments, the ML model(s) (e.g., NN(s), LLM(s), adapters) can be further-tuned by optimizing the parameters thereof (e.g., by tuning connection weights between nodes by minimizing the prediction error of the output data until the ML model(s) achieves a particular level of accuracy required by the user). For example, backpropagation through time may be used to iteratively and recursively determine a gradient descent with respect to the weights, and then the weights tuned to improve the performance of the particular ML model. In any case, the tuned parameters and ML model(s) can be securely stored so as to only be accessed/used by an authorized analyser.

The parameters of the ML model(s) 203 may be fine-tuned during or after each analysis operation to improve the functionality thereof. For example, any learning or customizations on top of the LLM can be retained in the context of the communication data that was processed. Any difference (refinements) between the parameters of the original ML model 203 and any trained ML model can be stored securely, such that the original ML model can be loaded for a particular analysis operation and any subsequent refinements to the parameters obtained by a trusted application and applied to the original ML model to provide a tuned ML model 203 for use by the analyser.

In further embodiments, the user device may provide communication data to a remote resource (e.g., a cloud service) for training or processing.

For example, the user device may analyze communication data at the user device using the ML model 203 described above and, when a possible scam is detected, the user device may send the communication data to a remote resource for further processing for confirmation (e.g., using a more powerful ML model).

In a further illustrative example, when the user device identifies a scam or when the user identifies a scam that is not detected by the user device running the ML model, the user may initiate a transfer of the communication data to a remote resource for training other ML models. Thus, the remote resource in this case may be responsible for provisioning ML models (or adapters) on other user devices, and the ML models that are to be provisioned can be trained to take account of undesirable communicative behaviour identified by other devices. Such functionality provides for federated learning.

Furthermore, the user device may receive an updated ML model (or parameters to be applied to a ML model in storage thereon) to take account of latest undesirable communitive behavior detected by other users.

Thus, the present techniques provide for analysis of communication data to identify undesirable communicative behaviour in exchanges between users. The analysis may be performed in real-time as the user receives communication data or the analysis may also be performed on previously received communication data in storage at the user device.

FIG. 5 is a flow diagram S300 of analyzing communication data in accordance with the present techniques.

At S302 the method starts.

At S304 an analyser (e.g., responsive to a stimulus) accesses communication data on a user device. The communication data may be processed in a trusted execution environment. Such security may be enforced using hardware and/or software as described in detail above (e.g., by way of realms, privilege levels, private cloud, secure storage etc.).

At S306, the analyser may convert at least a portion (i.e., some or all) of the communication data to a format that can be input to an ML model. The communication data may comprise different modes or types of data (e.g., audio, text, reaction data) and the conversion may be performed using, for example an ML model. For example, a first neural network may be used to convert voice audio (e.g., a voice memo) to text; a second neural network may be used to convert one or more images or other data to text; a third neural network may be used to convert text to a required format for the ML model.

At S308, the converted communication data is provided as an input to an ML model which analyses (e.g., using a tuned ML adapter) the communication data and determines whether the communication data comprises undesirable communicative data.

At S310, an alert may be provided to the user (E.g., via a display or a speaker), or to another person or resource (e.g., a parent of the user, a guardian, police, social services etc.)

At S312, the method ends.

The embodiments described above generally describe the communication data being processed on-device, which preserves privacy for a user. However, such functionality may not be suitable for a constrained device such as a mobile phone (e.g., due to processing constraints, storage constraints and/or power constraints).

Thus, in embodiments, the communication data and any user request (or stimulus) may be encrypted at the user device and the encrypted data provided to a remote resource for processing. Such a remote resource may be, for example, a trusted compute container on a remote resource (e.g., cloud compute). The communication data may be decrypted and processed at the remote resource in a similar manner described above in FIG. 4. The remote resource may then analyse the communication data to determine whether the communication data comprises undesirable communicative data. Such functionality may allow for a more powerful ML model to be used at the remote resource compared to a mobile device which may be relatively constrained (e.g. power, processing, storage) compared to the remote resource. To maintain the security of any data that may be revealed by changes (or deltas) made to the ML model in the course of the processing (such as learning-based refinement of the weights or other additional data generated during execution of the ML model for this instance) the deltas may be securely deleted from the e.g., cloud environment on completion of the instance, or they may be returned to the device to be stored securely for future use, while the copy in the remote resource (e.g. cloud environment) may be securely deleted.

The communication data, ML model(s) and output data may be stored in secure storage, such that the data is only accessible by a trusted application running on the user device.

Furthermore, the present techniques can be used on-device, so that a network connection is not required. Additionally, or alternatively, a trusted remote compute service (e.g., cloud compute) can provide the functionality in accordance with the present techniques.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

The system depicted in FIG. 3 may comprise features, for example, of a client computing device and/or a server computing device, in an embodiment. It is further noted that the term computing device, in general, whether employed as a client and/or as a server, or otherwise, refers at least to a processor and a storage connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals.

The term electronic file and/or the term electronic document, as applied herein, refer to a set of stored storage (memory) states and/or a set of physical signals associated in a manner so as to form a file thereby at least logically (e.g., electronic) and/or an electronic document. That is, it is not meant to implicitly reference a particular syntax, format and/or approach used, for example, with respect to a set of associated storage states and/or a set of associated physical signals. If a particular type of file storage format and/or syntax, for example, is intended, it is referenced expressly. It is further noted an association of storage states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical storage, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, storage states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as storage states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

1. A method performed at a computing resource comprising:
obtaining, at the computing resource, communication data of a messaging application;
executing a ML model to analyze at least one pattern in at least one portion of the communication data;
identifying in the pattern, based on the analysis, at least one pair of indicators predictive of undesirable communicative behavior;
initiating one or more actions responsive to detecting the indicators of undesirable communicative behavior in the at least one portion of communication data.

2. The method of claim 1, wherein identifying the at least one pair of indicators predictive of undesirable communicative behavior comprises identifying indicators predictive of a fraud attempt; or
wherein identifying the at least one pair of indicators predictive of undesirable communicative behavior comprises identifying indicators predictive of incitement to dangerous behaviour; or
wherein identifying the at least one pair of indicators predictive of undesirable communicative behavior comprises identifying indicators predictive of improper behaviour towards a vulnerable person.

3. The method of claim 1, wherein the computing resource comprises a mobile computing resource.

4. The method of claim 1, wherein the computing resource comprises a cloud computing resource.

5. The method of claim 1, wherein executing the ML model to analyze the at least one portion of the communication data comprises:
executing, at the computing resource, the ML model in a trusted execution environment.

6. The method of claim 5, wherein executing the ML model in the trusted execution environment comprises executing the ML model in a trusted zone of a processing device.

7. The method of claim 5, wherein executing the ML model in the trusted execution environment comprises executing the ML model in a realm of a cloud environment.

8. The method of claim 7, wherein executing the ML model in a realm of a cloud environment comprises executing the ML model solely in connection with attested realm elements.

9. The method of claim 8, wherein executing the ML model solely in connection with attested realm elements comprises using a single attested channel for communications to and from the realm.

10. The method of claim 1, wherein the communication data comprises a mixture of media types.

11. The method of claim 10, wherein the mixture of media types comprises one or more of: text data, voice data, video and/or audio media data and reaction data.

12. The method of claim 1, further comprising:
transmitting, from the computing resource to a further remote computing resource, the communication data;
executing, at the further remote resource, a further ML model to analyze at least one pattern in the at least one portion of the communication data:
initiating one or more actions at the further computing resource responsive to detecting the at least one pair of indicators predictive of undesirable communicative behavior.

13. The method of claim 12, wherein initiating the one or more actions at the user device comprises outputting an alert at the user device or a further computing resource.

14. The method of claim 13, wherein outputting the alert comprises:
generating the alert as a text output and/or an audio output on the computing resource or a further computing resource.

15. The method of claim 12 further comprising:
providing, from the computing resource to the further computing resource, communication data when the at least one pair of indicators predictive of undesirable communicative behavior is detected in the at least one portion of communication data.

16. The method of claim 1 comprising:
receiving, from a further computing resource an updated ML model;
executing the updated ML model to analyze the at least one portion of the communication data.

17. The method of claim 1 further comprising:
training the ML model responsive to the analysis to provide an updated ML model;
obtaining, at the computing resource, further communication data;
executing the updated ML model to analyze at least one portion of the further communication data;
identifying, based on the analysis, at least one further pair of indicators predictive of undesirable communicative behavior;
initiating one or more actions responsive to identifying the at least one further pair of indicators predictive of undesirable communicative behavior in the at least one portion of the further communication data.

18. The method of claim 1, wherein identifying at least one pair of indicators predictive of undesirable communicative behavior comprises identifying a time series of indicators in the at least one portion of communication data.

19. A computing resource comprising:
a processor;
communication circuitry to receive communication data from another resource;
storage to store communication data of one or more messaging applications and one or more ML models;
where the processor is operable to:
access, in the storage at the device, the communication data;
execute an ML model to analyze at least one pattern in at least one portion of the communication data;
identify in the pattern, based on the analysis, at least one pair of indicators predictive of undesirable communicative behavior; and
initiate one or more actions responsive to detecting the indicators of undesirable communicative behavior in the at least one portion of communication data.

20. A computer program comprising computer program code to, when loaded into a computer and executed thereon, cause the computer to perform the method of claim 1.
